(19) United States
(12) Patent Application Publication
(10) Pub. No.: US 2004/0130788 A1
(43) Pub. Date: Jul. 8, 2004

(54) Optical filter and filter for touch panel type display

(76) Inventor: Kazuhiko Minami, Yamagata Pref (JP)

Correspondence Address: 3M INNOVATIVE PROPERTIES COMPANY, PO BOX 33427, ST. PAUL, MN, 55133-3427, US

(21) Appl. No.: 10/450,575

(22) PCT Filed: Jan. 18, 2002
(86) PCT No.: PCT/US02/05741

(30) Foreign Application Priority Data
Feb. 2, 2001 (JP) 2001-26809
Jun. 22, 2001 (JP) 2001-189580

(51) Int. Cl. G02B 27/00

(52) U.S. Cl. 359/601

(57) ABSTRACT

An optical filter includes a louver film and an adhesive layer that is fixedly provided on the back surface of the louver film and used to adhere the louver film to a surface, which optical filter can be adhered to the surface of a touch panel without leaving any gap between the touch panel surface and the optical filter and thus causes no malfunction of the touch panel, even when the louver film is warped or curled, and which can be easily removed from the touch panel at any desired time and refixed. The adhesive layer of the optical filter has a peel strength of 0.1 to 3 N/25 mm which is measured against a surface of a polyethylene terephthalate film at a peeling rate of 90 inch (about 229 cm)/min. at a peeling angle of 90 degrees.

### TECHNICAL FIELD

The present invention relates to the improvement of an optical filter comprising a louver film and an adhesive layer which is used to adhere the louver film to an adherent surface.

The optical filter of the present invention is used with being adhered to the screen of an optical display such as a liquid crystal display, in particular, a touch panel type optical display, and functions as a privacy filter which can prevent a person other than a user or an operator from peeping at the screen from the side direction.

### BACKGROUND

In general, a liquid crystal display (which may be called a liquid crystal display device) comprises a liquid crystal display panel (screen) (hereinafter occasionally referred to as “liquid crystal panel”) and a light source, that is, a backlight which illuminates the liquid crystal panel from its back surface (a surface opposite to the displaying surface).

The liquid crystal panel comprises a pair of first and second polarizing plates and a liquid crystal layer interposed between them. The polarizing plates are placed so that the polarization axis of the first polarizing plate (the first polarization axis) and that of the second polarizing plate (the second polarization axis) form a certain angle, for example, they are orthogonalized. An example of the backlight is an edge-light type backlight which comprises a light-guide plate and a light source which supplies light in the light-guide plate from the edge face of the plate. Also, a beneath type back light, in which a light source is placed just beneath the back surface of the liquid crystal panel, is used.

However, in the case of the illumination with the above backlight, the light beam which has transmitted through the liquid crystal panel, exits in directions (side directions) remote from the front direction of the display surface. Thus, the liquid crystal display can be seen not only by a user or an operator positioned in the front direction but also by a person standing at a site in the side direction apart from the front direction. Therefore, it is difficult to guard the privacy of the user. Furthermore, when the liquid crystal display is an automobile-loaded equipment such as a car navigation system, etc., the reflection of the panel on a windshield may interfere with the eyesight of a driver.

Therefore, to guard the privacy and to prevent the reflection on the windshield, a film having a plurality of minute louvers (or louver-form elements) inside, that is, a louver film, is installed in the optical filter which is attached to the display screen so that the unnecessary propagation of the transmitted light beam from the liquid crystal panel in the side directions. The louver film achieves such an effect that the louvers built in the film control the propagation directions of the light beams which are transmitted through the louver film in a specific exiting angle range. Thus, the unnecessary exiting of the light beams which have transmitted through the liquid crystal panel in the side directions can be effectively prevented. Such a louver film is also called a light control film.

The structures, production and applications of the louver films are disclosed in some prior publications.

For example, U.S. Pat. No. RE27,617 discloses a method for producing a louver film by skiving a billet consisting of alternating plastic layers having a relatively low optical density (transparent) and a relatively high optical density (colored). When the billet is skived, the colored layers provide louver-form elements which collimate the light beam, and these elements can extend in the direction perpendicular to the surface of the louver film according to the specification of the above patent.

U.S. Pat. No. 3,707,416 discloses a method for slanting the louver-form elements, which collimate the light beam, in relation to the surface of the louver film. U.S. Pat. No. 3,919,559 discloses a method for gradually changing the slant angles of the louver elements which collimate the light beam.

U.S. Pat. No. 5,254,388 discloses a louver film having a plurality of minute louvers which comprise outer regions with a relatively low optical density and an inner region with a relatively high optical density. Thereby, the effective optical density of the medium through which the light propagates increases in direct proportion with the path length of the medium though which the light should pass. Therefore, the most of the light beams which hit the minute louvers are effectively absorbed. Thus, the light-control film having less ghost images can be provided.

JP-A-8-224811 discloses the formation of a pressure-sensitive adhesive layer on at least one of the main surfaces (surface and back surface) of a louver film and the covering of the adhesive surface of the adhesive layer with a transparent protection plastic film to prevent the damage of the louver film in use. The transparent plastic film may optionally have a release layer. The release layer is removed to allow the adhesive layer to expose and the louver film is adhered to a suitable adherent (a panel, etc.) to obtain a finished product.

The pressure-sensitive adhesive layer used in the above patent comprises a pressure-sensitive adhesive containing a self-adherent polymer. The self-adherent polymer is tacky at a room temperature (about 25° C.). The self-adherent polymer may be obtained by polymerizing a monomer composition which becomes an adhesive and preferably transparent state after polymerization. The specific example of the self-adherent polymer disclosed in JP-A-8-224811 is a crosslinked self-adherent polymer which is obtained by polymerizing, with UV light, a monomer composition containing 90 parts (parts by weight) of isooctyl acrylate, 10 parts of acrylic acid, 0.2 part of a photopolymerization initiator and 0.1 part of an optically active crosslinking agent. This example provides a pressure-sensitive adhesive suitable for permanently adhering the louver film to the adherent.

As is well known in the field of adhesives, the pressure-sensitive adhesives may be made repeelable by the suitable selection of kinds and amounts of a crosslinking agent contained therein, additives (repeeling property-imparting components), etc.

One example of the commercially available louver film is “Light Control Film” manufactured and sold by Minnesota Mining and Manufacturing Company.

### SUMMARY OF THE INVENTION

As described above, when the louver film is adhered to the screen of the liquid crystal display, it functions as the optical filter (i.e. a privacy filter), which prevents the unnecessary exit of the light beams, which pass through the liquid crystal panel, in the side directions, and thus guards the privacy. However, it has been found that there is a tendency to prefer that such an optical film is not permanently fixed to the display screen but it can be removed from the screen at any desirable time and easily refixed to the screen.

Thus, the inventor tried to allow an optical filter to be easily fixed to the display screen, removed at any desirable time and then easily refixed thereto using a repealable adhesive layer as an adhesive layer which adheres the optical filter having the louver film to an adherent. In this way, desired good results were achieved in many cases, but there are following problems to be solved. That is, when conventional repeelable adhesive layers are used as such, the optical filters may have some defects as optical filters for touch panel type displays.

In the case of the touch panel type display, a transparent touch panel is provided on the front face of the liquid crystal panel, and the information displayed on the liquid crystal panel can be seen through the touch panel. The touch panel has a structure such that transparent conductive layers are provided on respective back surfaces of a pair of transparent plates made of glass or polyethylene terephthalate (PET) and the transparent conductive layers of the transparent plates are faced each other in a non-contact state with leaving a thin gap between them. When an operator of the touch panel presses a specific position of the surface of one of the transparent plates with a finger or a pen, the transparent conductive layer on the one of the transparent plates is in contact with the conductive layer of the other transparent plate, and thus the two plates become electrically continuous only at the specific position. A sensor electrically senses the position which becomes electrically continuous, and thus the position which is pressed by the operator is detected. Such touch panel type displays are used in portable terminals such as personal computers, personal data assistants (PDA), etc.

The louver films tend to warp or curl due to their production processes. When the degree of such warp or curl is relatively large, a gap is formed between the surface of the touch panel and the optical filter, if the adhesive force (peel strength) of the adhesive layer, which adheres the optical film having the louver film to the touch panel, is too low. If such a gap is formed, malfunction occurs since the other position of the optical filter is in contact with the touch panel, when the operator presses the specific position of the touch panel through the optical filter. However, if the adhesive force of the adhesive layer is made too large, it becomes difficult to remove the optical filter at a desired time and refix it. Thus, the present inventor has improved the adhesive layer of the optical filter, and completed the optical filter which does not cause any problem with the touch panel.

Accordingly, one object of the present invention is to provide an optical filter comprising a louver film, which can be adhered to the surface of a touch panel without leaving any gap between the touch panel surface and the optical filter and thus causes no malfunction of the touch panel, even when the louver film is warped or curled, and which can be easily removed from the touch panel at any desired time and refixed.

To solve the above problems, the present invention provides an optical filter comprising a louver film and an adhesive layer which is fixedly provided on the back surface of said louver film and used to adhere said louver film to an adherent surface, characterized in that said adhesive layer has a peel strength of 0.1 to 4.5 N/25 mm which is measured against a surface of a polyethylene terephthalate film at a peeling rate of 90 inch (about 229 cm)/min. at a peeling angle of 90 degrees, and repeeling properties from said adherent surface.

### BRIEF DESCRIPTION OF THE DRAWING

FIG. 1 is a cross sectional view of one example of the optical filter of the present invention.

### DETAILED DESCRIPTION

The optical filter of the present invention is characterized in that it comprises a louver film and an adhesive layer which is fixedly provided on the back surface of the louver film and used to adhere the louver film to an adherent surface (for example, the surface of a touch panel), and the adhesive layer has the repeeling properties against the adherent surface. Thus, the optical filter can be easily removed at any desired time and refixed.

The adhesive layer (repeelable adhesive layer) has an adhesive force (peeling strength) in a specific range so that the optical filter can be easily removed and refixed. That is, the adhesive layer has a peel strength of 0.1 to 4.5 N/25 mm against the surface of a polyethylene terephthalate (PET) film. Herein, the peel strength, which may be referred to as “peel strength against PET”, is measured at a peeling rate of 90 inch (about 229 cm)/min. at a peeling angle of 90 degrees.

Since the peel strength against PET of the adhesive layer is 0.1 N/25 mm or more, the optical filter of the present invention can be adhered to the touch panel with leaving no gap between them even when the louver film itself is warped or curled. Accordingly, when the operator presses the specific position of the optical filter adhered to the surface of the touch panel and in turn presses the specific position of the touch panel through the optical filter, no other position of the optical filter will be in contact with the touch panel and thus the malfunction of the touch panel is prevented.

Since the peel strength against PET is no larger than 4.5 N/25 mm, the optical filter can be easily removed from the touch panel without damaging the touch panel and refixed. Since the touch panel often has the laminate structure as described above, it is preferable to use the repeelable adhesive layer having as low peel strength as possible to avoid the destruction of the laminate structure of the touch panel, when the optical filter is removed from the surface of the touch panel.

Accordingly, from the above viewpoint, the peel strength against PET of the adhesive layer is preferably from 0.5 to 4.0 N/25 mm, particularly preferably from 1 to 3.6 N/25 mm.

The optical filter of the present invention is adhered to the screen of the touch panel type optical display in use, and it is particularly suitably used as a privacy filter or a peeping-preventing filter, which prevents a person other than a user (or an operator) from peeping at the screen from the side direction. That is, in one preferred embodiment, the present invention provides a filter for a touch panel type display comprising an optical filter according to the present invention, wherein the adherent surface is a display screen of the touch panel type display, the optical filter can be adhered to the display screen so that no malfunction is caused, and it can be repeeled from the display screen without damaging the display screen.

(Optical Filter)

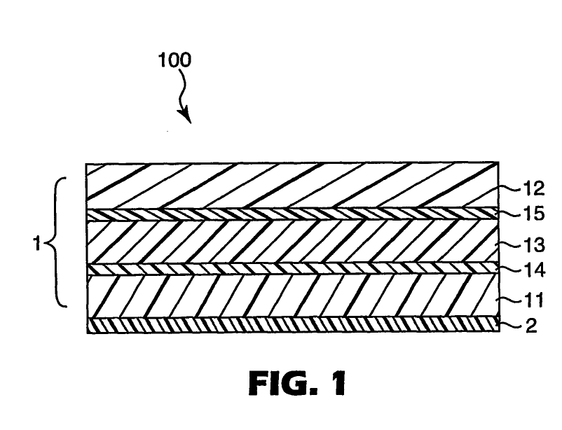

As shown in FIG. 1, the optical filter (100) of the present invention generally comprises the louver film (1) and the repeelable adhesive layer (2) which is fixedly provided on the back surface of the louver film (1).

The louver film (1) has the louver layer (13) with minute louvers (louver-form elements) (not shown) inside, and the backside substrate (11) and the surface side substrate (12), which are fixed to the louver layer (13). The substrates (12) and (13) are fixed to the louver layer (13) with the permanent adhesive layers (14) and (15) respectively. The repealable adhesive layer (2) is provided so that it is adhered to substantially the whole area of the back surface of the backside substrate (11) (that is, the surface of the substrate (11) opposite to the surface to which the louver layer is adhered).

Preferably, the material of each substrate (11) or (12), each permanent adhesive layer (14) or (15) and the repeelable adhesive layer (12) has as high transparency as possible. The light transmittance of each material is usually at least 80%, preferably at least 85%, more preferably at least 90%. Herein, the “light transmittance” means a total light transmittance, which is measured with a spectrophotometer or a color meter having a spectrometric function using light having a wavelength of 550 nm.

The two substrates (11) and (12) are preferably installed in the louver film (1), since they suppress the warp or curl of the louver layer (13) and in turn the warp or curl of the louver film comprising the louver layer. The surface side substrate (12) also functions as a protective layer which protects the louver layer (13) from the damages.

The substrates (11) and (12) may be formed of polymer sheets. As the polymers of the polymer sheets, polyesters (e.g. PET, polyethylene naphthalate (PEN), etc.), acrylic polymers, vinyl chloride polymers, polyurethane, and the like may be used. Preferably, the polyesters are used. The polyester may be used also as a material of the transparent plate constituting the touch panel. Accordingly, the optical filter of the present invention is excellent since it does not deteriorate the operability and the appearance of the touch panel, when it is closely adhered to the screen of the touch panel type display. Thus, it is preferable to use the polymer sheets having substantially the same appearance (gloss, etc.) and physical properties (flexural modulus, etc.) as those of the transparent plate of the touch panel as the substrates (11) and (12).

The thickness of each of the substrates (11) and (12) is usually from 25 to 200 μm.

The permanent adhesive layers (14) and (15) may be formed of a conventional adhesive such as a pressure-sensitive adhesive, a heat-sensitive adhesive, a curable adhesive, etc. In general, the adhesive comprises a self-adherent polymer, which is preferably crosslinked. The self-adherent polymer means a polymer which exhibits tackiness at room temperature (about 25° C.).

The self-adherent polymer of the permanent adhesive layers may be, for example, an acrylic polymer, a nitrile-butadiene copolymer (e.g. NBR, etc.), a styrene-butadiene copolymer (e.g. SBR, etc.), an amorphous polyurethane, a silicone polymer, etc. The self-adherent polymer may comprises one or more of these polymers.

The self-adherent polymer may be prepared by polymerizing a monomer mixture containing a specific starting monomer or monomer(s). The polymerization method may be a conventional one such as solution polymerization, bulk polymerization, emulsion polymerization, etc.

A suitable self-adherent polymer is, for example, an acrylic polymer, since the acrylic polymer having a high transparency can be easily produced or readily available. The acrylic self-adherent polymer is usually obtained by polymerizing a monomer mixture containing (A) an alkyl acrylate having 4 to 8 carbon atoms in the alkyl moiety and (B) a (meth)acrylic monomer having a carboxyl group in the molecule. Furthermore, other (meth)acrylic monomer or a monomer having an unsaturated double bond (vinyl bond, etc.), which is copolymerizable with the monomers (A) and (B) may be additionally used.

The thickness of each permanent adhesive layer is usually from 5 to 50 μm.

The peel strength of the repealable adhesive layer (2) is determined as described above. The composition and thickness of the repeelable adhesive layer and the surface properties (surface roughness, etc.) of the adherent surface are preferably selected so that the peel strength of the repeelable adhesive layer against the actual adherent, which is measured at a peeling rate of 90 inch/min. at a peeling angle of 90 degrees, is from 0.1 to 4.5 N/25 mm, preferably from 0.5 to 4.0 N/25 mm, more preferably from 1 to 3.6 N/25 mm.

In the embodiment of FIG. 1, a difference (F−R) of the peel strength (F) of the permanent adhesive layer (14) on the backside and the peel strength (R) of the repeelable adhesive layer (2) is preferably at least 3 N/25 mm, more preferably at least 5 N/25 mm, when the both peel strengths are measured against a PET surface at a peeling rate of 90 inch/min. at a peeling angle of 90 degrees. When the difference of the peel strengths (F−R) is too small, the backside substrate may be peeled from the louver layer, when the optical film is repeatedly detached and attached.

The peel strength (F) of the permanent adhesive layer (14) is not limited but is usually from 4 to 50 N/25 mm. The peel strength of the permanent adhesive layer (15) is not limited either but is usually from 4 to 50 N/25 mm.

The optical filter of the present invention can be produced as follows:

Firstly, an adhesive film is provided by placing the permanent adhesive layer (14) on the surface of the backside substrate (11) and the repealable adhesive layer (2) on the back surface of the backside substrate (11). Next, the adhesive film and the louver layer (13) are adhered and fixed each other through the permanent adhesive layer (14) to form the louver layer having the repeelable adhesive layer. Finally, the surface side substrate is adhered and fixed to the louver layer having the repeelable adhesive layer through the permanent adhesive layer (15) to finish the optical filter. The permanent adhesive layer (15) may be placed on the back surface of the surface side substrate (12) and then the substrate with the permanent adhesive layer is adhered to the surface of the louver layer, or the permanent adhesive layer (15) is provided on the surface of the louver layer having the repeelable adhesive layer and then the surface side substrate (12) is laminated. Alternatively, the louver layer and two substrates are laminated to prepare the louver film 1, and then the repeelable adhesive layer (2) is fixed to the back surface of the backside substrate (11) to finish the optical filter.

Otherwise, the louver layer (13) and one or both of the two substrates are fusion bonded at their adhesive surfaces without the use of the permanent adhesive layer.

(Repeelable Adhesive Layer)

The repeelable adhesive layer preferably contains a self-adherent polymer and a repeelability-imparting compo-nent. Thus, the peel strength of the repealable adhesive layer is easily controlled in the above-described range.

For example, a crosslinking agent is preferably used as a repeelability-imparting component in a relatively large amount to crosslink the self-adherent polymer so that the cohesive force of the repeelable adhesive layer is increased. In addition, a crystalline polymer is preferably used as a repeelability-imparting component to decrease the tack of the adhesive surface of the repeelable adhesive layer or to impart the thermal repeeling properties to the repeelable adhesive layer. The kind and amount of the repeelability-imparting component are suitable selected so that the desired effects are attained and the transparency of the repeelable adhesive layer is not deteriorated. The repeelability-imparting component, which can be preferably combined with the self-adherent polymer, will be explained in detail below.

In the present invention, the self-adherent polymer used in the repeelable adhesive layer is also a polymer which is tacky at room temperature (about 25° C.). Examples of the self-adherent polymer are acrylic polymers, nitrile-butadiene copolymers (e.g. NBR, etc.), styrene-butadiene copolymers (e.g. SBR, etc.), amorphous polyurethane, silicone polymers, etc. These polymers may be used independently or as a mixture of two or more.

The self-adherent polymer may be obtained by polymerizing a monomer mixture comprising the specific starting monomer(s). In general, the polymerization method is solution polymerization, bulk polymerization, emulsion polymerization, etc.

One example of the suitable polymer is an alkyl acrylate copolymer. The alkyl acrylate copolymer used as the self-adherent polymer may be obtained by polymerizing a monomer mixture comprising (a) an alkyl acrylate having 4 to 8 carbon atoms in the alkyl group and (b) a (meth)acrylic monomer having a carboxyl group in the molecule. Other (meth)acrylic monomer or other monomer having an unsaturated double bond (e.g. a vinyl group, etc.), which is copolymerizable with the above monomers (a) and (b), may be used together with the monomers (a) and (b).

Examples of the monomer (a) are n-butyl acrylate, isobutyl acrylate, isooctyl acrylate, 2-ethylhexyl acrylate, etc. Examples of the monomer (b) are acrylic acid and methacrylic acid.

Examples of the other (meth)acrylic monomer include phenoxyethyl acrylate, phenoxypropyl acrylate, 2-hydroxyethyl(meth)acrylate, 2-hydroxypropyl(meth)acrylate, 2-hydroxymethyl(meth)acrylate, hydroxy-3-phenoxypropyl acrylate, glycidyl (meth)acrylate, acryloylbenzophenone, etc.

The total content (by weight) of the monomeric units derived from the monomers (a) and (b) based on the whole units of the above self-adherent polymer is usually at least 40 wt. %, preferably at least 45 wt. %, more preferably at least 50 wt. %.

(Crosslinking Agent)

When the self-adherent polymer is crosslinked, it is easy to control the peel strength of the repeelable adhesive layer in the desired range. In such a case, a crosslinking agent is generally used.

As the crosslinking agent, a polyfunctional isocyanate compound, an epoxy resin, a bisamide crosslinking agent, etc. may be used. These compounds react with the carboxyl group of the self-adherent polymer or the crosslinkable functional group which is optionally contained such as a hydroxyl group to crosslink the self-adherent polymer so that the repeeling properties are improved.

The polyfunctional isocyanate compound may be a compound, which is synthesized from a raw material containing at least one diisocyanate selected from the group consisting of isophorone diisocyanate, diphenylmethane diisocyanate (MDI), hydrogenated MDI and 1,6-hexanediol isocyanate.

For example, (1) a compound prepared by reacting atriol (e.g. 1,1,1-trimethylolpropane, etc.) with the above diisocyanate to form a urethane, or (2) a compound having a biuret or isocyanate structure obtained by reacting the above diisocyanates each other may be used. To adjust the NCO equivalence, a crosslinking agent prepared by reacting the above compound and a diol such as polycaprolactonediol may also be used.

Examples of the epoxy resin are bisphenol A epoxy resins, bisphenol F epoxy resins, cresol-novolak epoxy resins, phenol-novolak epoxy resins, etc. The epoxy equivalence of the epoxy resin is usually from 70 to 400, preferably from 80 to 300.

As the bisamide crosslinking agent, bisaziridine derivatives of dibasic acids such as isophthaloyl bis(2-methylaziridine) can be used. The bisamide crosslinking agent is particularly preferable since it can react with the self-adherent polymer having the carboxyl group at a relatively low temperature and easily achieve a sufficient crosslinking density.

When the repeeling properties are imparted to the repeelable adhesive layer using the above crosslinking agent but no other repeelability-imparting agent, the content of the crosslinking agent is from 1 to 5 wt. parts based on 100 wt. parts of the self-adherent polymer. When the amount of the crosslinking agent is less than 1 wt. parts, the repeeling properties may deteriorate. When the amount of the crosslinking agent exceeds 5 wt. parts, the optical filter may not be adhered to the surface of the touch panel without leaving any gap between them, if the louver film itself is warped or curled. From such a point of view, the content of the crosslinking agent is preferably from 1.5 to 4 wt. parts based on 100 wt. parts of the self-adherent polymer.

When no crystalline polymer is contained, the use of such a relatively large amount of the crosslinking agent can particularly easily improve the repeeling properties of the adhesive layer.

(Crystalline Polymer)

As described above, the crystalline polymer can be used as the repeelability-imparting agent contained in the repeelable adhesive layer. The crystalline polymer can adjust the tack of the adhesive surface of the repeelable adhesive layer on a low level, and impart the thermal peeling-easy properties to the repeelable adhesive layer. In addition, the crystalline polymer preferably has a high compatibility with the self-adherent polymer so that the adhesive layer does not lose the transparency.

As the crystalline polymer, polycaprolactone or a crystalline polyurethane having crystalline polyol units such as polycaprolactone in the molecular chains is preferable. An adhesive composition, which is prepared by combining the crystalline polymer such as polycaprolactone or the crystalline polyurethane having crystalline polyol units in the molecular chains with the self-adherent polymer compatible with such a crystalline polymer at a temperature higher than the melting point of the crystalline polymer and then crosslinking the self-adherent polymer, has good thermal peeling easiness.

A preferable example of the self-adherent polymer having a high compatibility with polycaprolactone and the crystalline polyurethane is an acrylic polymer, which is prepared by polymerizing (A) a (meth)acrylic monomer having a hydroxyl group in the molecule, (B) a (meth)acrylic monomer having a phenyl group in the molecule, (C) a (meth)acrylic monomer having a carboxyl group in the molecule, and (D) an alkyl acrylate having 4 to 10 carbon atoms in the alkyl group.

The components (A) and (B) are useful to increase the compatibility of the self-adherent polymer with the crystalline polymer. The component (C) is useful to crosslink the self-adherent polymer with the above-described crosslinking agent. The component (D) is useful to maintain the good adhesion force (peel strength) of the adhesive composition (the repeelable adhesive layer) against the adherent until the polymer exhibits the thermal peeling-easy properties on heating.

Examples of the (meth)acrylic monomer (A) having the hydroxyl group in the molecule are 2-hydroxyethyl(meth)acrylate, 2-hydroxypropyl(meth)acrylate, 2-hydroxymethyl(meth)acrylate, hydroxy-3-phenoxypropyl acrylate, etc. Examples of the (meth)acrylic monomer (B) having the phenyl group in the molecule are phenoxyethyl acrylate, phenoxypropyl acrylate, etc.

Such a self-adherent polymer may be prepared by copolymerizing a monomer mixture comprising the above acrylic monomers by a conventional method such as solution polymerization.

The total amount (by weight) of the units derived from the components (A) and (B) is usually from 40 to 90 wt. %, preferably from 41 to 85 wt. % of the whole polymeric units of the self-adherent polymer. When the amount of the units having the above two functional groups is too low, the compatibility of the self-adherent polymer with the crystalline polymer tends to decrease. When the amount of the units having the above two functional groups is too high and thus the amount of the components having the other functional groups is too low, the above-described properties may not effectively be improved. For example, the decrease of the crosslinkability may deteriorate the effect to prevent the transfer of the adhesive.

The amount of the units derived from the component (B) in the whole polymeric units of the self-adherent polymer is at least 0.5% by mole, preferably at least 1% by mole, more preferably from 5 to 25% by mole.

Among the above-described allcyl acrylate copolymers, a butyl acrylate copolymer, which is prepared by copolymerizing a monomer mixture containing a relatively large amount (in general, at least 45% by mole) of butyl acrylate, has good compatibility with polycaprolactone or the crystalline polyurethane.

Accordingly, the combination of such a butyl acrylate copolymer and polycaprolactone or the crystalline polyurethane can effectively control the tack of the adhesive surface of the repeelable adhesive layer on a low level and impart the thermal peeling-easy properties to the repealable adhesive layer. In addition, such a combination is useful to prevent the deterioration of the transparency of the adhesive layer.

Also, when the repealable adhesive layer comprising the crystalline polymer is used, it may contain the crosslinking agent to crosslink the self-adherent polymer. In this case, the content of the crosslinking agent is usually from 0.05 to 5 wt. parts based on 100 wt. parts of the self-adherent polymer.

(Louver Layer)

The louver layer used in the present invention is a film having minute louvers (or louver-form elements) inside the film. In general, the louver layer comprises light-transmitting parts and minute louver elements which shield light.

Preferably, the light-transmitting part has a larger width than the width of the louver element (a size of the louver element in the direction in parallel with the surface of the louver layer and perpendicular to the lengthwise direction of the louver element), so that the light transmittance of the optical filter as a whole does not decrease. The width of the light-transmitting part is preferably from 50 to 500 μm, more preferably from 70 to 200 μm.

Preferably the width of the louver element is smaller than that of the light-transmitting part, so that the light transmittance of the optical filter as a whole does not decrease. The width of the louver element is from 1 to 100 μm, preferably from 10 to 50 μm. The angle of the louver element is usually from 40 to 90 degrees. The angle of the louver element means an angle between the surface of the louver layer and the plane of the louver element. When the louver element lies at right angles with the surface of the louver layer, the angle of the louver element is 90 degrees.

The thickness of the louver layer can be suitably determined according to the application of the optical filter. As the thickness of the louver layer decreases, the effect to control the propagation direction of light tends to decrease. When the thickness of the louver layer is large, it is difficult to decrease the total thickness of the optical filter. Accordingly, the thickness of the louver element is preferably from 10 to 1,000 μm, more preferably from 40 to 500 μm.

The light-transmitting parts of the louver layer are preferably made of a polymer having a high transparency. As such a polymer, a thermoplastic resin, a thermosetting resin, a resin curable with an actinic ray such as UV ray, etc. can be used. Examples of such resins include cellulose resins such as cellulose acetate butyrate, triacetylcellulose, etc.; polyolefin resins such as polyethylene, polypropylene, etc.; polyester resins such as polyethylene terephthalate, etc.; polystyrene; polyurethane; polyvinyl chloride; acrylic resins; polycarbonate resins; and the like.

The louver elements may be formed from a light-shielding material which can absorb or reflect light. Examples of such a material include (1) dark pigments or dark dyes such as black or gray pigments or dyes, (2) metal such as aluminum, silver, etc., (3) dark metal oxides, and (4) the above-described polymers containing the dark pigments or dyes.

The louver layer may be produced by the following method, which is disclosed, for example, in the patent specification cited in the prior art section:

Firstly, a layer containing the light-shielding material is fixed to one main surface of the polymer film used as the light-transmitting part to form the louver-form element, that is, a laminate film consisting of the polymer film and the light-shielding material layer. A plurality of such laminate films are prepared and laminated to form a precursor louver film in which the polymer film and the light-shielding material layers are alternately arranged and fixed each other. Such a precursor louver film is skived at a desired thickness along the direction (lamination direction) perpendicular to the main surface (laminated plane) of the precursor film to obtain the louver layer.

As the louver film having the louver layer, a commercially available louver film may also be used. A commercially available louver layer for a louver film may be used as the louver layer used as a component member of the optical filter according to the present invention. One specific example of the commercially available louver film is Light Control Film manufactured and sold by Minnesota Mining and Manufacturing Company.

### EXAMPLES

### Example 1

In this Example, an optical filter was produced by laminating a surface side substrate, a louver layer, a backside substrate and a repeelable adhesive layer in this order, as shown in FIG. 1.

The louver layer was a louver layer having a thickness of about 150 μm and a view angle of 90 degrees (a louver layer “OAG 90” (with no protective layer) for a louver film manufactured by 3M). As the backside substrate, an adhesive film with a slightly adhesive layer (UC-38AC manufactured by UNITIKA) was used. This adhesive film comprised a PET film as a base material and had a total thickness of 53 μm. The above slightly adhesive layer was used as the repeelable adhesive layer. The slightly adhesive layer contained a crosslinked acrylic adhesive polymer. The surface side substrate (a protective layer of the louver layer) was a PET film having a thickness of 38 μm (UHD-38 manufactured by UNITIKA).

The light-transmittance of the surface side substrate was 92%, while that of the backside substrate (including the adhesive layer) was 90%. In the louver layer, the width of the light-transmitting part was 100 μm, and that of the louver element was 10 μm.

The supplied surface side substrate, louver layer and backside substrate were adhered and fixed each other through adhesive layers comprising an acrylic adhesive polymer to complete the optical filter of this Example. The total thickness of the optical filter was 260 μm.

The optical filter of this Example was attached to the screen of a touch panel type liquid crystal display FLORA 220FX NP3 manufactured by HITACHI LTD.) through the above repeelable adhesive layer, and subjected to a practical test.

As the result of the test, the effect to prevent peeping was sufficient. That is, when the screen was viewed from a side direction apart from the front direction by an angle of about 45 degrees, the information displayed on the screen was not readable.

Furthermore, the surface of the touch panel and the optical filter could be adhered with leaving no gap between them, and no malfunction occurred when the analog characters were inputted and the buttons on the touch panel were pushed. The once attached optical filter was easily detached and reattached. After the reattachment, the surface of the touch panel and the optical filter were closely adhered, and no malfunction occurred during the operation of the touch panel.

Separately, the adhesive film having the slightly adhesive layer was adhered to a PET film (BUM-100 manufactured by UNITIKA having a thickness of 100 μm) to obtain a test specimen, and the peel strength was measured. The measurement of the peel strength was carried out using a peel strength tester (I-Mass Tester, MODEL SP-102C manufactured by Imass, Inc. (USA)) at a peeling angle of 90 degrees and a peeling rate of 90 inch/min. (about 229 cm/min.). The peel strength against the PET film of the adhesive layer of the optical filter produced in this Example was 1.0 N/25 mm.

The test specimen was prepared as follows:

The adhesive film having the slightly adhesive layer was cut in a size of 15 cm×25 mm to obtain a sample. The sample was press adhered to the PET film, which had been cleaned with isopropanol, using a roller defined in JIS Z 0237 (having a weight of 2 kg) at 20° C., 65% RH and then kept standing for 3 hours under the same conditions. Then, the specimen was subjected to the peel strength measurement.

### Comparative Example 1

The practical test was carried out in the same way as in Example 1 except that Privacy Filter PF-12B (manufactured by 3M) (a louver film having no adhesive layer) was used in place of the optical filter.

The louver film was attached to the touch panel by adhering four corners of the film to the touch panel using four pieces of an adhesive tape, each of which was prepared by cutting an adhesive tape available from Sumitomo 3M (SCOTCHCAL®) in a plane size of 12 mm and 20 mm with a radius of curvature R of 2 mm at the four corners of each piece.

Between the privacy filter and the touch panel, gaps of about 2 mm or less were partly left. Thus, malfunction such that an analog character was not read occurred when it was inputted.

### Example 2

An optical filter of this Example was produced in the same manner as in Example 1 except that an adhesive film with a slightly adhesive layer was produced as follows:

A PET film (UC-38 manufactured by UNTICA; thickness: 38 μm) was used as a backside substrate, and a coating liquid containing a self-adherent polymer and a crosslinking agent was applied on the back surface of the PET film to form a repealable adhesive layer (a slightly adhesive layer). The thickness of the repeelable adhesive layer was 15 μm.

The polymer in the repeelable adhesive layer was synthesized by a solution polymerization using a starting material mixture containing 92.5 wt. parts of butyl acrylate and 7.5 wt. parts of acrylic acid. A bisamide crosslinking agent was added to the solution of this self-adherent polymer in acetone with a non-volatile concentration of 30 wt. % to prepare the above coating liquid. The weight ratio of the self-adherent polymer to the crosslinking agent was 97:3 (non-volatile base). The peeling strength against PET of the, repeelable adhesive layer was 2.15 N/25 mm, when measured by the same method as in Example 1.

With the optical filter of this Example, the practical test was carried out in the same way as in Example 1. No malfunction occurred during the operation of the touch panel. The optical filter was easily detached and reattached. After the reattachment, no malfunction occurred during the operation of the touch panel.

### Example 3

An optical filter of this Example was produced in the same manner as in Example 2 except that SK DAIN 1604 N (manufactured by SOKEN KAGAKU KABUSHIKIKAISHA; available in the form of a tackifier liquid having a non-volatile content of 42 wt. %; raw material composition of self-adherent polymer: 96 wt. parts of butyl acryalate and 4 wt. parts of acrylic acid) was used as a self-adherent polymer, and the weight ratio of the self-adherent polymer to the crosslinking agent was 96.4:3.6 (non-volatile base).

The peeling strength against PET of the repeelable adhesive layer was 3.55 N/25 mm, when measured by the same method as in Example 1.

With the optical filter of this Example, the practical test was carried out in the same way as in Example 1. No malfunction occurred during the operation of the touch panel. The optical filter was easily detached and reattached. After the reattachment, no malfunction occurred during the operation of the touch panel.

### Comparative Example 2

An optical filter of this Example was produced in the same manner as in Example 2 except that the weight ratio of the self-adherent polymer to the crosslinking agent was 99.6:0.4 (non-volatile base).

The peeling strength against PET of the repeelable adhesive layer was 7.1 N/25 mm, when measured by the same method as in Example 1. Thus, the repeeling property of this filter was low.

Consequently, in the practical test carried out with the optical filter of this Comparative Example, the detachment of the optical filter was difficult, and thus the touch panel might have been damaged unless the optical filter was carefully detached.

### Comparative Example 3

An optical filter of this Example was produced in the same manner as in Example 2 except that the weight ratio of the self-adherent polymer to the crosslinking agent was 99.4:0.6 (non-volatile base).

The peeling strength against PET of the repeelable adhesive layer was 5.1 N/25 mm, when measured by the same method as in Example 1. Thus, the repeeling property of this filter was low.

Consequently, in the practical test carried out with the optical filter of this Comparative Example, the detachment of the optical filter was more difficult than the optical filters of Examples.

What is claimed:

1. An optical filter comprising a louver film and an adhesive layer which is fixedly provided on the back surface of said louver film and used to adhere said louver film to an adherent surface,
characterized in that said adhesive layer has a peel strength of 0.1 to 4.5 N/25 mm which is measured against a surface of a polyethylene terephthalate film at a peeling rate of 90 inch (about 229 cm)/min. at a peeling angle of 90 degrees, and repeeling properties from said adherent surface.

2. The optical filter according to claim 1, wherein said adhesive layer comprises a crosslinked self-adherent polymer.

3. The optical filter according to claim 2, wherein said self-adherent polymer is crosslinked with a crosslinking agent, and an amount of said crosslinking agent is from 1 to 5 parts by weight based on 100 parts by weight of said self-adherent polymer.

4. A filter for a touch panel type display comprising an optical filter according to claim 1, wherein said adherent surface is a display screen of the touch panel type display, said optical filter can be adhered to said display screen so that no malfunction is caused, and it can be repeeled from said display screen without damaging said display screen.
